(19) United States
(12) Patent Application Publication
(10) Pub. No.: US 2012/0253517 A1
(43) Pub. Date: Oct. 4, 2012

(54) Necktie Personal-Extender/Environment-Integrator and Method for Super-Augmenting a Persona to manifest a Pan-Environment Super-Cyborg for Global Governance

(75) Inventor: Caleb Suresh Motupalli, Vijayawada (IN)

(73) Assignee: ROTTELAILLU (HOUSE OF BREAD), VIJAYAWADA (IN)

(21) Appl. No.: 13/516,443

(22) PCT Filed: Oct. 8, 2010
(86) PCT No.: PCT/IN10/00669

§ 371 Date: Jun. 15, 2012

Related U.S. Application Data
(60) Provisional application No. 61/290,104, filed on Dec. 24, 2009.

(30) Foreign Application Priority Data
Feb. 17, 2010 (IN) 404/CHE/2010

(51) Int. Cl. G05B 19/00

(52) U.S. Cl. 700/264

(57) ABSTRACT

The present invention discloses a system and method for a morphological solution to the macroscopic problem of n-entropy (i.e. loss of control/information) of the prevailing global anarchy by super-augmenting a persona to manifest a pan-environment super-cyborg for global governance. Through a Christocratic Necked Service Oriented Architecture (CNSOA) model, the method of said system, categorizes the world people into two spaces, Bridespace and Christocratic-space. Each member or citizen of Bridespace and consenting Christocratic space is incorporated with Bridal Wedding Garments, namely holy goods & services & Necktie imitating Personal-Extender that includes a data processing device connected to a global network. Each member's Persona and proximity Meatspace are augmented by recasting the metaphoric environment of the data processor (network-is-the-supercomputer) as a Necktie Personal-Extender/Environment-Integrator. The ultimate objective of this invention is to provide a viable regulatory system for global governance to bring justice, peace and wealth for rightful people. With the Necktie Personal-Extender/Environment-Integrator that extends man into both space and time (eternal life) to solve all his problems, it is asserted that a union with the divine is achievable for all of mankind.

### CROSS REFERENCE TO RELATED WORK

This application claims the benefit of provisional patent application Ser. No. U.S. 61/290,104 filed on 2009 Dec. 24 and Indian provisional patent application Ser. No. 404/CHE/2010 filed on 2010 Feb. 17 by the present inventor.

### COPYRIGHT NOTICE

### Copyright© 1989-2012 Motupalli, Caleb Suresh

A portion of the disclosure of this patent document contains material which is subject to (copyright or mask work) protection. The (copyright or mask work) owner has no objection to the facsimile reproduction by any-one of the patent document or the patent disclosure, as it appears in the Patent and Trademark Office patent file or records, but otherwise reserves all (copyright or mask work) rights whatsoever.

### FIELD OF INVENTION

The present invention relates to a morphological solution and a handle for the same to the macroscopic problem of n-entropy i.e loss of control/information in the globalized world, and more particularly with the use of Christocratic Necked Service Oriented Architecture so that even Global Cyborgic Conglomerate Christs/Superhumans can be manifested.

### BACKGROUND OF THE INVENTION

The Computer, the Robot/Android and the Network-is-the-Super-Computer, all purport to imitate the real life objects, namely the brain, man as a whole, and the nervous system respectively.

John Gage of Sun Microsystems supposedly coined the phrase, “The Network-is-the-Computer” to describe the emerging world of distributed computing such as with the Internet. Indeed the Internet has become some sort of an “On Demand Supercomputer” for anyone who wants something, so much so that even as early as 2003 an editorial appeared in an Indian news daily titled, “Is Google god?”

As you can see the trend is very worrisome. The “big beast” spoken of in the Bible is not an exaggeration but an imminent reality. We are living in a global economy spurred-in by globalization whether we like or not. But there is no global polity for the global economy. Global economy more or less runs in global anarchy through the Network-is-the-Super-Computer. As a result we witness a global, socioeconomic, political, environmental, religious, and legal crisis, facing the nations. With several contenders for the position of world-governor, it is nonetheless paving the way for a single global polity. However, the only legitimate one happens to be that of Christ. “Worthy is the Lamb that was slain to receive power, riches, wisdom, might, honour, glory, and blessing” (Revelation 5:11-14, The Holy Bible).

In the Network-is-the-Super-Computer amorphous architecture, the user is overwhelmed with n-entropy (loss of information/control) of n uncertainties coming in all directions from not only n machine-nodes in the grid (Internet) but also from n nefariously intentioned users (i.e. “word-swords”—Ephesians 6:17 and Hebrews 4:12, The Bible; Information Theory by Claude E. Shannon). It is not just a case of security from malware but security from those who have hijacked the “Network-is-the-Super-Computer” in more ways than those from which we are supposedly or commonly protected against.

For instance any mal-intentioned person with a basic knowledge of the “Network-is-the-Super-Computer” can hijack whole corporations or even governments as demonstrated in the business world today and well publicized in the media as honest and forthright people/corporations/nations. In the words of Paul Krugman the 2008 Nobel Prize winner and columnist of New York Times, (Source: Deccan Chronicle 24 Jul. 2007), these people are “digital robber barons.” Therefore, it is not only true that everyone is getting levelled as Thomas L. Friedman observes in his book, “The World is Flat,” but also that the “mountains” are becoming “valleys” and those that ought to be valleys are becoming mountains. The enemy is reigning supreme to the utter disgust of man who has placed his trust in this current world system. Justice is not being meted out to people as Adam Smith claims would happen in his perfect capitalistic world, where people out of their own self-interest will take care of the poor. Rather, what prevails is a generally accepted global anarchy viz. this n-entropy. For instance, speaking of “On demand Supercomputing” Johnathan Schwartz of Sun Microsystems writes in his Blog: “ . . . by On Demand I mean accessible through a browser, with a credit card . . . this isn't yesterday's definition of On Demand, involving [blah, blah, blah]. Nope! Our definition is just like eBay's: you bring a browser and a credit card, we offer the service. No fuss, no muss. We believe the simplicity, accessibility and affordability of this service changes the face of computing for all organizations, large and small, public or private . . . So have at it! Go to Network.com later this week, grab a Paypal account, and experience for yourself what its like to use one of the world's largest supercomputers. Without having to house it, manage it, power it, administer it, provision it . . . or buy it.”

Gone are the days when governments could regulate the dissemination of Supercomputing know-how to thwart anyone using it for military purposes! Today, people can have not just the supercomputing know-how but supercomputers themselves are readily at their disposal. Societies have overemphasized on Science and Technology—on the What we can do—and have marginalized humanistic thinking—on the What we should do. Artistic activity has been relegated to the mathematicians. We should take advice from Yuri Borev, who pointed out in his book on Aesthetics: “At various periods in our lives most of us engage in some sort of artistic activity, intuitively or deliberately, with varying degrees of success. But only someone with artistic capability can create artistic values of social interest.” The question is: what are these artistic values of social interest?

Slowly the blinders are falling from the public eye. Paul Krugman writes, “What happened to America's Internet lead? Bad policy! Specifically, the United States made the same mistake in Internet policy that California made in the energy policy: It forgot—or was persuaded by special interests to ignore—the reality that sometimes you can't have effective market competition without effective regulation.”

If the ultimate objective of mankind is to let those who hold to truth and goodness to prevail, then giving unregulated access to this on-demand supercomputer namely the “Network-is-the-Super-Computer” to every Tom, Dick and Harry is not wise to the nth degree. God is in control and there is no doubt about that; but God wants his people also to be in control, especially His beloved son in whom He is well pleased. With ever increasing rise of terrorism and faced with dilemmas for pre-emptive wars, empowering the Royal Priesthood is of paramount importance and is the current Social Interest. We need to create artistic values to empower the Royal Priesthood!

The domain of Medicine may belong to Medical Doctors and the domain of Aeronautics may belong to Aeronautical Engineers, but the domain of Government, especially global governance, belongs to God's holy ones i.e. the Royal Priesthood because they are qualified for that role, knowing Justice and Love!

As said earlier, the Computer, the Robot and the Network-is-the-Super-Computer, all purport to imitate the real life objects, namely the brain, man as a whole, and the nervous system respectively.

There is no disputing that both the Computer and the Network-is-the-Super-Computer are good at doing a lot of processing; but “that is more like moving muscle.” Such low level processing is delegated to the machine, and the real and strategic decision making is made in our own minds because the human being is always on top of things making all things his slaves in the end. What is more, this attribute of enslaving is desirable by all humans and God himself issues the Divine Magna Charta saying, “Be fruitful and multiply; fill the earth and subdue it; have dominion over the fish of the sea, over the birds of the air, and over every living thing that moves on the earth” (Genesis 1:28, The Holy Bible).

An article on Sociable Robots, Deccan Chronicle 1 August, 2007 raises a question on “What is the disadvantage in designating the machine as a self-thinking machine with the attributes of “situated” and “embodied”. If we can delegate some of the lower level thinking to it, this emerges with a solution for self thinking.

Even though this is already being done these days subconsciously and man has learned to accept it; that is not really the goal of the Computer paradigm. What is ostensibly there to assist and help, purports to replace humans, beginning with those in “the second wave” (The Third Wave by Alvin Toffler). We may not be biased against productivity gains through technology. But just consider: In this culture that harps on woman's liberation . . . rather than extend and compliment man in a synergistic manner, the Computer too purports to replace man like the feminists of today. The fact that there is so much of fanfare around the new “Sociable Robots” with Bill Gates commenting that Personal Robots are at the same stage that Personal Computers were in the 1970s (Deccan Chronicle 1 August, 2007), is proof that these technologies are trying to imitate not just the grunt work but also the more common traits that make a human, human. Man as a whole is being swallowed up in his own fool hearted policies.

The inventors of the Computer/Network-is-the-Super-Computer/Robot propose self serving machines that are machine centric. The machine centric arrangement of the Computer paradigm not only places a psychological integration barrier between the user and the machine-network but also speciously purports to enslave humans even though it cannot in the end game. The word “Computer” is indeed a misnomer. But the thugs who are behind these “black box” inventions are clandestinely enslaving the second wave humans using them. We are dealing with intellectual property of all sorts here. All our thinking is first out of our heads and left bare for whoever has access to the inside of the box through the so called “network.” Ever since the cat was out of the box, the Computer has taken a lesser role and a whole different meaning has come to it. Now, it even gives respect to humans and comes in many forms. But before we go into each of these forms, an introduction to how technologies evolved is essential.

If one traces back the etymology of terms and names used to define technologies and their jargon, it will become apparent that they had as important a role to play, as the technologies themselves. The reason being: objects are what they are because of their embodied cognition and vice versa. In other words, the nature of an object is determined by the form of the object and vice versa. This is true of not only natural objects but technological objects as well, which can be steered in that direction if at all possible. For instance, the first computers could hardly be called computers in the strictest sense of the term because the word computer means: “That which can put together thinking.” In other words a computer is supposed to be a thinking machine, which, as we know today, it can never be, because thinking entails consciousness. But the inventors of Computers tried to steer the research and development in the direction of attaining a true Turing Machine i.e. a true Computer.

Now, it is a well acknowledged fact and a given, that old technologies—like the Computer—could find new uses with the aid of object technologies and other “Black-box Modernization” techniques. Systems need not be designed from scratch—objects only need to be assembled together in new ways and integrated with new user interfaces for a new system.

Metaphors are used extensively not only for brand names but also in technology jargon so that the functions of the product they represent become suggestive and operable. These cognitive technologies recast the black-box and offer a modern perception of thinking and learning new ways for problem solving with said technologies. These bring along with them what is called “metaphor environments”—the upper-level user interfaces over on top of the actual media—which serve as “handles” to operate the objects they represent. Without these handles they are inoperable. For instance, before Calculators were invented, if the Calculator label was not given to the electronic device, it will be unnerving to figure out what that device is meant to do. As early as biblical times, it is a known fact that people think of new concepts/things in terms of what they already know about old concepts/things. So “people learn and retain concepts pertaining to one system by metaphorizing what they already know about another.

Metaphors are such powerful learning tools so much so that whole architectures of systems or subsystems they encapsulate get readily programmed in the minds of the users and thereby they can intuitively use the features of the system architecture and also retain them in memory. In other words, there is high information economy in the use of metaphors to cognitively represent systems. A single Metaphor can be used to wrap a whole system through its Metaphor Environment as has been the case with many suggestive brand names. Thus targeted design of systems using metaphors of a specific domain made technology. They imitated those real life objects brought by the metaphor. They offered heuristics to keep the developer as well as the user ‘in the flow’ with the system so that real life functionality of the parent object could be metaphorized. Thus, Metaphors by themselves are not only Learning Systems, but also top level Vision/Drafter Systems, System [Interface] Builders, and System Development Aides, where the modules of the system may be developed and filled-in by the developers because they are enabled to “stay in the flow” of System Development.

“Metaphor Environment Control System” (US patent) is the generic prior art (it appears) from which the following specific ones (handles) can be hypothetically derived:
1. Pencil/Pen: limited functionality
2. Type Writer: An improvement over pen/pencil but still limited functionality.
3. Remote Control System: It is demeaning for a context where humans are part of the system.
4. Answering Machine: Callers can be screened before receiving the call but function wise, it is limited.
5. Microprocessor: Though Very Large Scale Integration is spoken of in connection with this, it does not “incorporate,” objects in the environment, full with head and body, let alone incarnate, because of the crude and obscure Imitating Real Life Object.
6. International Business (Electronic) Machine: Ambiguous if used in today's context.
7. Super/Personal Computer: Though better than sociable “Giant/Personal Robot/Androids,” the arrangement, which sets the user at the same level as the machine, does not take into consideration the user's strengths at the system design and specification stage to be called a user centred system. Moreover, the Computer relic inhibits the electronic machine to be perceived as a real extension to the mind. It impedes research because it limits our thinking of the machine as a mere substitute to the human mind rather than as a compliment and an infinite Extender. There is no deliberate synergy because both the human and the machine are meant to operate independently. Mechanical models transliterated to computers are always less efficient. Operating the machine in the same paradigm as the human computer, new ways of operating the machine are precluded—the user is limited to essentially that which could be done in the world of human-to-human interaction. Reliance on human-to-human communication paradigms have blinded the designers of prior art GUIs such as the PARC User Interface to the far greater potential of the machine to extend the user/corporation.
8. Think Pad: Though it tones down the purporting, the word, “Pad” is at the other extreme, which minimizes the power of machine.
9. “Windows” or “Gateway” or “Vista”: Though these also tone down the purporting, they reduce the user to a passive spectator, which at the most lends itself to a serendipity tool.
10. “Explorer” and “Browser”: tones down the power of the machine to a mere serendipity tool.
11. “Active server” (pages)/Web Services: Though they “serve,” they are inadequate user interfaces with poor metaphor environments because they do not “marry” the system architecture with the rightful and essential user(s) to form one whole while also giving respect to those user(s). They are merely Servant Computers! Thus they are more difficult to learn than the present embodiment of the invention.
12. Service Oriented Architecture (SOA)/Infrastructure As A Service: Although services and a business's SOA architecture are often strictly defined as those set of processes that can be bundled together and transported over a global network, governance of an SOA, implementation of an SOA, operation of an SOA and management of an SOA are not defined. The reason being the SOA architecture lacks a “neck” (a desirable feature for governing processes) in the architecture of the amorphous network, which is today more like a prairie land. Even though some of the above inventions give respect to the user, they do not help to expressively extend or augment the power of the user by incorporating in the user (meaning, into the rightful and essential user) every other objects' power in his realm/domain. Secondly, while purporting to be something it can never be (though Computers are used to subdue and enslave others in a clandestine way), the Computer—even Servant Computer—inhibits the machine-network to be perceived as a real complimenting infinite Extender to the user to serve and augment his persona.
13. “Red Hat” (inadvertently named) Linux: Though the arrangement is suggestive of an extension of the mind, it places the user himself under the machine's control, so to speak, while also rendering the machine itself a passive object in view of the passive nature of Hat Metaphor Environment. Another disadvantage when compared with my embodiment's arrangement is that it does not provide for the integration of the real environment as well, along with Cyberspace. My embodiments have a Cyberspace Integrated-Augmented Meatspace.
14. “Digital Nervous System”: Though it imitates the head-and-members-of-the-human-body, it is still machine centric in that it is only “digital,” making the Computer the head (CPU/the Central Nervous System) and all the other members including the users—all of whom use the PARC User Interface—as slaves in the Peripheral Nervous System. My embodiments have the User as the Head and the Apparatus as the “neck” and the System as the Peripheral Nervous System.
15. “Head and Members of the Body” or simply put, ‘Corporation’ by Apostle Paul in the Bible: Though the thus constituted corporation—an invention of the Service Industry—imitates the real life body, exploits the head-and-members-of-the-body metaphor environment and it also places the Chief in the head position in the arrangement or architecture. But it is still only Fleshspace/Meatspace. Whereas the present invention incorporates in the Fleshspace even Cyberspace in an overall system composition. In the embodiment of the present invention the Spirit operates upwards from the “neck” as well as downward from the “neck”. The Spirit is given the preeminent position for the world to see that He pervades the whole environment and controls through the Chosen Ones at the Bridal Metaphor Environment Control System or eThrone, which is at the cross-section of the Body's “neck”.
16. “Personal Digital Assistant”: Though this comes close to what we are proposing, in that it is an assistant, it still purports to replace the human assistant rather than augment her. It is also too verbose and people are forced to use the acronym, “PDA,” which means nothing for someone who does not know the device. Moreover, it does not represent the integration aspect. The present invention is succinct with high information economy.
17. Other kinds of Prosthetic devices: These again try to substitute; for instance a prosthetic leg if there is no leg, etc. These do not capitalize on the remaining faculties of the body especially with the brain that can perceive with other senses and accomplish the same task by controlling other equipment. In other words, as Mr. Karunanadhi, Chief Minister of Tamilnadu would put it: the so-called handicapped can be “differently abled” without prosthetics. For instance, if one does not have eye sight, he could very well use his other faculties, or as we will see, other appendages, to compensate for the loss of eye sight.
18. Enterprise Service Bus (ESB): Only useful in the framework of a network. But the Network still remains amorphous.

Moreover, the common problem that runs through all these inventions is that they empower in a clandestine manner anyone who gets their hands on these inventions, while the rightful humans are left to skimp for themselves. Thus global anarchy is exacerbated with every new invention in this paradigm. The governance or polity being established through a Governance System of any type needs to be implemented to overcome all such common problems. It is not only desirable but also mandatory that the scope of such a system be global because we live in a globalized world with a global economy. This present invention solves the majority of the drawbacks discussed.

### SUMMARY OF THE INVENTION

The present invention disclosed a morphological solution to the macroscopic problem of n-entropy i.e. loss of control/information in the globalized world that is giving rise to global anarchy. The present invention provides a viable regulatory system for global governance to bring justice, peace and wealth for rightful people.

A Christocratic Social Architecture for a Christ-headed Environment (eThrone) is proposed where everyone is given their due and is judged/glorified/integrated/placed. Each subject of the kingdom is given a “rapture kit” which consists of a Necktie Personal-Extender to be “tied-upward” (worn on top of a Fine Linen Environment Integrator Garment imitating global network) as an indication of roping-in or tying-in the fruit/good (Goods & Services) that he bore. A super-synergy of global proportion results at the constituted e-neck of the Bride's body that ultimately serves as an eThrone or an e-donkey that Christ sits on, upon His second coming.

The present invention comprises a method where the profiles of GOODS & SERVICES of a rightful people who have subscribed, accented or acquiesced to the evangelism of the kingdom of heaven are processed in the Christocratic Necked Service Oriented Architecture (CNSOA). The people are divided into two groups in the architecture. One group to be in the upper (inverted) pyramid is called Bridespace and another to be in the bottom (upright) pyramid is called Christocratic-space or Governed-space in the architecture. The bridespace is further divided into two, they are those who will be in the eastern region of the earth and those who will be in the western region of the earth. Likewise, the bottom Upright Pyramid, hereafter called Christocratic-space or Governed-space.

In one aspect of my exemplary embodiment, each member/citizen of Bridespace is set with a Necktie Personal-Extender/Environment-Integrator. The Necktie Personal-Extender/Environment-Integrator is an apparatus that consists of a data processing device connected to a global network with handwriting, speech, gesture and image synthesizing/processing software, a camera (optional), a ear-phone with microphone (optional) and a projector (optional) on and about their forehead and body. Necktie is spoken of in a figurative sense and is applicable at the System functionality (usability) level and not mandatorily applicable at the apparatus/hardware level, i.e. it is not for ornamental purposes. With the Necktie (imitating) Personal-Extender/Environment-Integrator, each member's Persona and proximity Meatspace is augmented by the data processor, which sees through the camera, microphone or touch-screens and processes all that we see, hear and touch and generates and projects through the projector or earphone, “smart” cyberspace in multi-media.

Through each member's governance, with the members themselves being micro-tied (governed) and integrated together into the body's architecture as with a necktie tying, it purportedly joins/marries each member with the head. The result is a Super-ordinate's Necktie Personal-Extender/Environment-Integrator imitating a corporate-necktie that figuratively/prosthetically/dynamically takes the place of a supposed missing frontal spinal column of a human body, purportedly extending (omni-presenting) him from the brain downwards into the whole environment for orchestrated care & management, and also simultaneously purporting to integrate the elements (through metaphor objects) of the environment harmoniously with the head.

In another aspect of the above exemplary embodiment, which when extrapolated and interconnected, it figuratively takes the shape of Clean-Linen wedding garments spread over a Bride/corporation/nation/world/environment, fulfilling the prophesy in Revelation 19:8 of The Holy Bible.

This is not only a shift away from the Computer paradigm, but also an improvement over the Multi-National Corporation (MNC)—an invention by the Lord Jesus Christ and Apostle Paul of the Service Industry—in terms of teleworking and telegoverning as we will see in more detail later.

Thus with such a Necktie (imitating) Personal-Extender/Environment-Integrator that extends him into both space and time (eternal life) and to solve all his problems, it is asserted that a union with the divine is achievable for mankind.

### BRIEF DESCRIPTION OF THE DRAWINGS

FIG. 1A shows the Top Section View of the Christocratic Necked Service Oriented Architecture of what the governing environment, namely the Bridal Metaphor Environment Governing System is like with 12 e-thrones (Necktie Personal-Extender/Environment-Integrator Metaphor Environments) in the geographic eastern world (of Lord's e-throne) and 12 to the geographic western world for the 24 Elders (Revelation 20:4);

FIG. 1B shows the functional Front view of the architecture with the blocks of the Christocratic Necked Service Oriented Architecture in the background;

FIG. 1C shows Back view of the above functional view, namely, the building blocks of the Christocratic Necked Service Oriented Architecture, which is distinguished with the tapering resource requirements, as it comes to the middle; thus enabling governance;

FIG. 1D shows the bottom view of the Christocratic Necked Service Oriented Architecture—as to how n-entropy space is handled; reduced using 7±2 soft or hard units (typically a mom-and-pop kiosks) at each level;

FIG. 2 shows a diagram of a scenario where the Proximity Meatspace and Cyberspace of three members collaborating are integrated and augmented using their Necktie Personal-Extender/Environment-Integrator Metaphor Environments.

FIG. 3 shows the Flow-chart of the Service Selection Policy's Implementation Process for the Christocratic Necked Service Oriented Architecture (CNSOA) from candidates who have either subscribed, accented or acquiesced in order to make up the Bridespace (the 1,44,000) or the Governance Services, which are structured as an inverted pyramid (a conventional wisdom in Biblical Christianity, briefly outlined later).

### DETAILED DESCRIPTION OF THE INVENTION

The present invention disclosed a morphological solution to the macroscopic problem of n-entropy i.e. loss of control/information in the globalized world with the use, by members/citizens, of a plurality of Necktie-Imitating Personal-Extender/Environment-Integrator and a Christocratic Necked Service Oriented Architecture of the world/environment to manifest even Global Cyborgic Conglomerate Christs/Superhumans.

Being that metaphor objects make up the primary aspect of the present exemplary embodiment, it can be categorized as a Cognitive Technology, Perception Model, Suggestive Learning System, Vision/Drafter System, System Interface Builder, and System Development Aid. Therefore, a commentary like style is adapted throughout, for describing the exemplary embodiment because that is what will ultimately enable the user to learn, “see” (perceive) and profitably put this kind of invention (cognitive technology) to maximum use.

Mode 1A—Christocratic Global Governance with eThrone by Super-augmenting Persona

### Introduction

To distinguish Meatspace and Cyberspace, we may pose the question, “Where is the brain,” and if the “self” is associated with the brain, one might expect to have the same answer as the question, “Where is the self?” For most everyday purposes, we plainly feel that our self extends out of our skin. However, much of what is inside the skin is not crucial to self. We are still who we are without many parts of our body. On the other hand, anybody who works intimately with tools knows that one's self extends out into the tool. When you drive a car, you feel the tires on the road. When you write with a pencil, you feel the texture of the paper through the tip of the pencil, just as clearly as if the pencil were an extension of yourself. And of course for many of us, our sense of self even embraces family and friends and out beyond.

### Meatspace:

In real life, which we call “Meatspace” we are prisoners in our own body, which is made up of flesh. Our interactions with the physical world are limited by what we can do with our own body parts. But self need not be restricted like this.

### Cyberspace:

Cyberspace on the other hand, is the virtual interactive experience through an electronic medium of computer (passé) networks. In concrete terms, it is the dynamic realization of electromagnetic energy through the application of Control and Communication technology. The machine, also known as “Network-is-the-Super-Computer”, can be perceived as an Extender of self as much as the pencil is an Extender of self. Remote parts can be manipulated with it. Thus Cyberspace allows our interactions with the physical world to go beyond the skin/Meatspace and into the remote corners of our natural and built environment.

Throughout the description, the suffix, “space” refers to “GOODS & SERVICES” or Laborspace or Meatspace integrated and augmented by Cyberspace as shown in FIG. 2 and described later in the context of the Necktie Personal-Extender/Environment-Integrator apparatus.

### Persona and Cyborg

The word “Persona” is defined by analytical psychologist C. G Jung as an individual's social faØade or front that reflects the role in life, the individual is playing. Any individual who “wears” or adorns such an Extender, which in this embodiment is synergistically organized, can super-augment his persona and manifest as a Pan-Environment Super-Cyborg, preferably as a wedded, indivine avatar of Christ. The word Cyborg is derived from Cyb[ernetic]+Org[anic] where Cybernetics is the science of control and communication in the animal and machine systems in terms of what they do rather than as animals/machines of what they are. Information is processed as an integrated-whole in order to achieve the objective, namely an eThrone for super-augmenting of persona to manifest a Pan-Environment Super-Cyborg (Corporate Avatar of Christ) that can orchestrate justice, peace, and wealth by mitigating the problem of n-entropy (loss of control due to n uncertainties) and thus arresting global anarchy.

As for the Christocratic Necked Service Oriented Architecture, the building blocks, almost like its predecessor “SOA”, are not only Services but also Goods. All aspects of Christocracy, whether they may be GOODS or SERVICES may be transcribed into bundled “space” or in our case Cyberspace Integrated-Augmented Meatspace that can be transported over a global network whether electronic or physical.

One important aspect of the present invention to be noted is that it harnesses the existing bonding or the integrated nature of the community in consideration. It is obvious that for a truly viable governing body, it is essential that the constituent units are well integrated and pledge allegiance to the supreme authority in the first place. Without this we are again bound to have entropy from within. Not only is the Bridespace, the rightful governing authority but they are inherently able, due to their loyalty to their head, the Christ. Moreover they need not be explicitly managed or governed because they do their job, which God has entrusted to them, out of their own free-will. This positions them as greater than the least i.e. servant of all, namely Christ, who shoulders the government with Bridespace. This sort of implicit binding or integration coupled with the workings of the “Necktie” apparatus, which extends all and simultaneously integrates all, sets the standard for the Christocratic-space as well.

### Bridespace Identification

Power for power-sake is very dangerous. C. S. Lewis noted that education makes criminals, only, more smarter criminals. In our right stewardship of technology, it is not enough to have the goal of creating a an eThrone for manifesting a Pan-Environment Super-Cyborg for the purposes of exercising control alone. The power of that Pan-Environment Super-Cyborg must also rest with the rightful people. Therefore, a Bridespace identification processes are used to arrive at the Governance-space or Governing Support-space.

The necktie that is typically worn by most businessmen is here held to be a prophetic symbol existing on man through the centuries to signify the unifying work of the Holy Spirit—who is the invisible controller and the preeminent Lord—in restoring man to his original perfect state to be in fellowship with God, even as man synergistically cooperates and works in concert with Him (Holy Spirit) and also with the rest of mankind with the use of such a Necktie Personal-Extender/Environment-Integrator. In other words, the necktie signifies that missing part in the perfect body of a human, namely the Front Spinal column as explained already in the Summary.

### Necktie

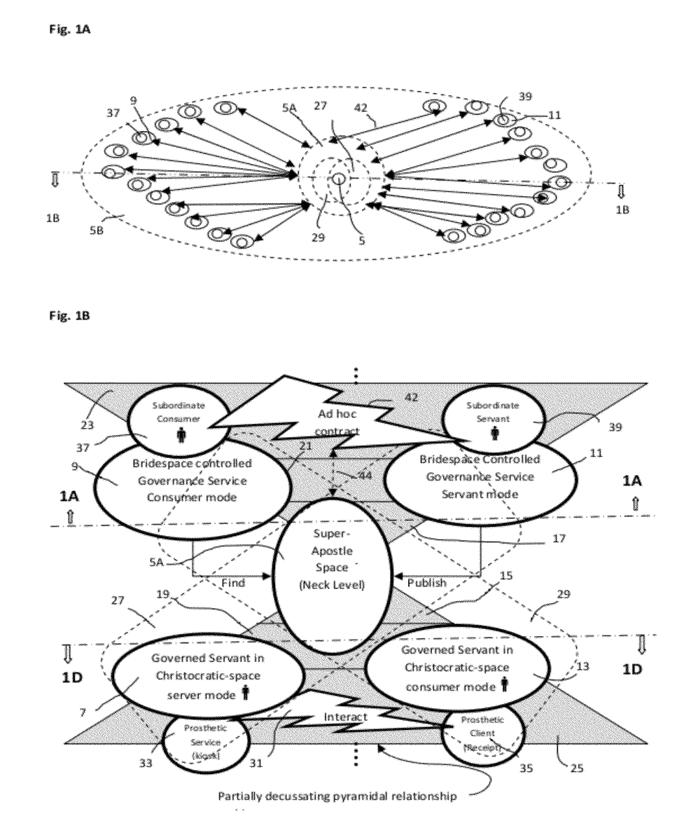

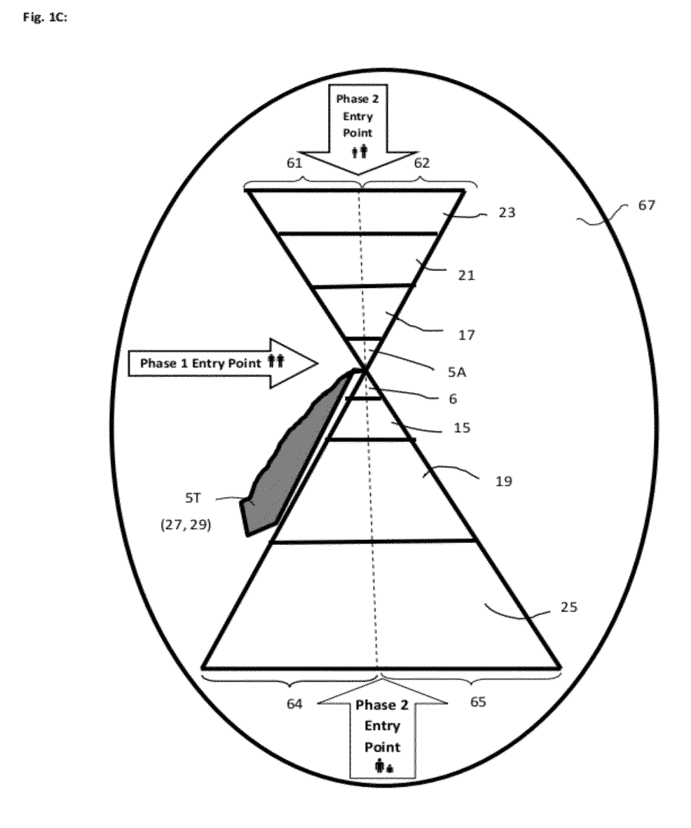

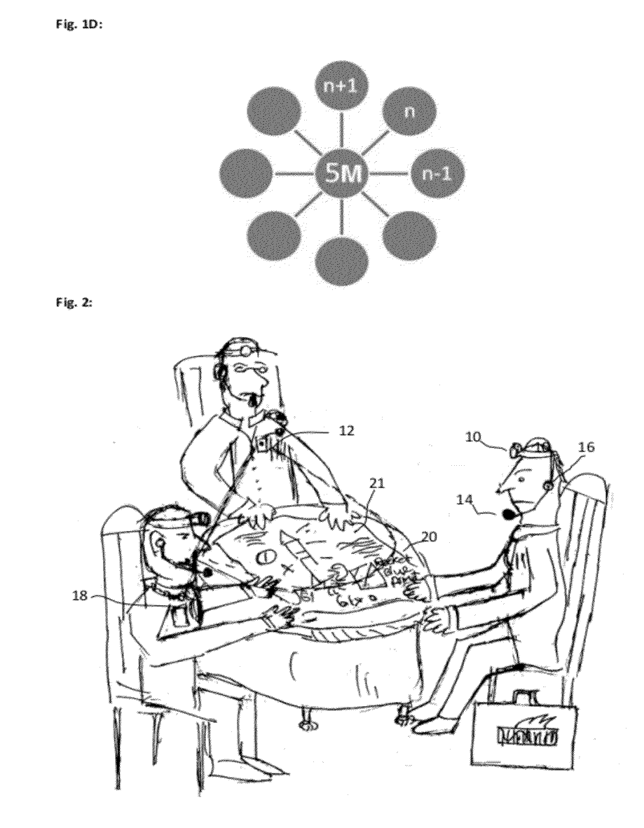

The Necktie Personal-Extender/Environment-Integrator purports to be a Mental-Prosthesis, which can enable him to plug into the any part of the natural or built environment and take control of that module. As the “Necktie” takes the place of the missing part in the perfect body of a human, namely the Front Spinal column and begins to subdue/control modules in the environment under the headship of Christ, it is seen as a harmonious cooperation with God, which in turn represents the GOODS & SERVICES, which is the result of our having subdued the elements of the earth, in keeping with “the divine Magna Charta” given to man in Genesis 1:28 (Scofield Study Bible). The consummation of the said wedding (plugging-in) is when a Lord's Necktie Personal-Extender/Environment-Integrator Ends 5T shown in FIG. 1C or “Ends” 27 and 29 shown in FIG. 1B is supposedly “tied” around the initial Christocratic-space that is yet without a neck—unmarried. The Lord's Necktie 5T that is shown in FIG. 1C is displayed only to show that there is a Life Manager or Lord (Holy Spirit) operating among men through the Lord's Necktie within the Blocks of the Christocratic Necked Service Oriented Architecture.

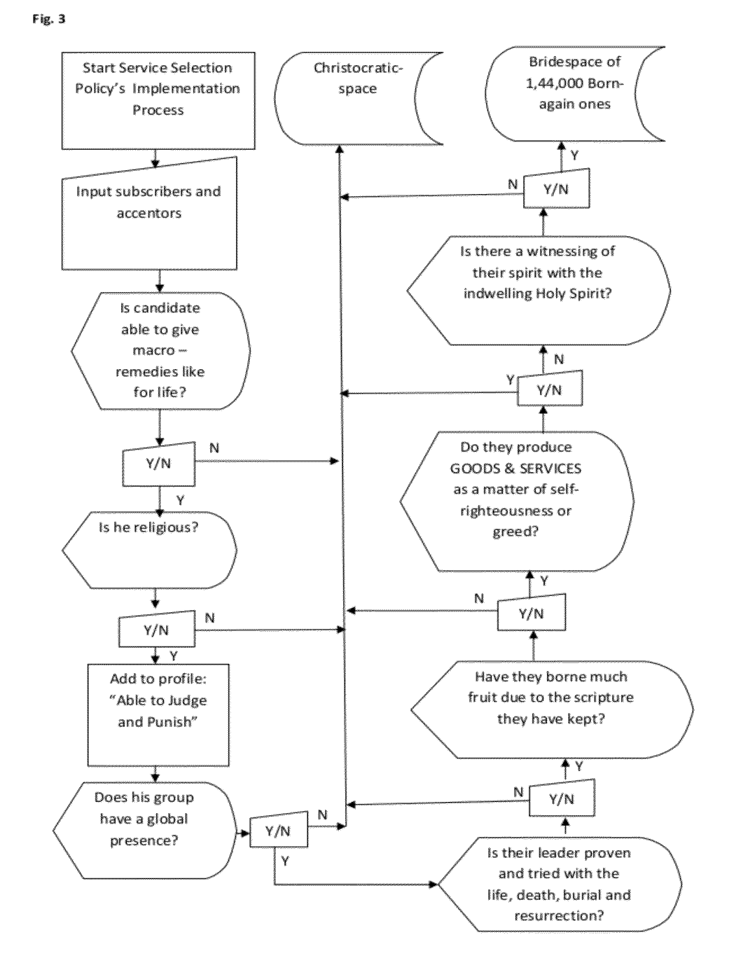

The Lord's Necktie Ends 27 and 29 shown in FIG. 1B can be anything from a Kiosk, a Cellular Phone with Simple Messaging Service (SMS) to a Paper Receipt Printer. This figurative “tying” of the Necktie around the initial Christocratic-space is the Service Selection Policy's Implementation Process of FIG. 3, which divides those who have subscribed, accented and acquiesced into primarily two divisions—the Bridespace consisting of blocks 5A, 17, 21 and 23 in FIG. 1B and FIG. 1C and Christocratic-space consisting of blocks 6, 15, 19 and 25 in the same FIG. 1B and FIG. 1C.

Separating Bridespace (the Governing Support-space) from the Christocratic-space (the Governed Support-space) in the first pass of the filtering process is prophetically supposed to fulfil the separation of the Sheep from the Goats on Judgment Day.

The Service Selection Policy's Implementation Process is essentially a custom set of assessments as shown in FIG. 3 and detailed later in the context of arriving at the rightful people-space. Each candidate Service is ranked and strategically placed for synergy in the System (body) with a Christocratic Necked Service Oriented Architecture so that it has a shape as shown in FIG. 1C for operability (in particular, governability), full with a Neck or Governor's-Space or Super-Apostle's-Space 5A shown in FIG. 1C and also shown in FIG. 1B in whom the Life Manager or Christ supposedly dwells to the greatest degree by his virtue of giving each and everyone their due. The thus constituted Cyberspace Augmented Bridespace or the Bridal Metaphor Environment Control System 5B shown in FIG. 1A, enables global governance by the manifested Pan-Environment Super-Cyborg through his super-augmented Persona.

Within the Bridal Metaphor Environment Control System 5B shown in FIG. 1A, each Apostle/Ambassador 37, who are in the geographical East, and 39, who are in the West have their own spaces 9s and 11s respectively, which serve as eThrones. These are chiefly indwelt through Interactions 42 & 44 by the Spirit, who is Lord and Life Manager 5.

The following steps are involved in embodying Mode 1A:

### Arriving at the Rightful People Space (Controller Use Cases) Using the Service-Selection-Policy's Implementation Process as Shown in FIG. 3

Peter M. Foreman observes to some extent, at ICAO Rio Conference 1998: Rather than produce humans with unprecedented capabilities at a later date by developing generalized systems for anyone, it is not only easier but also right to include the rightful humans in the system design and specifications right from the start. Just as developing Medical Systems, domain experts, namely, doctors, need to figure in the system specification and design right from the start, etcetera. In developing effective Governing Systems, God's holy ones need to figure in the specification and design right from the start because the purview of governing lies with them.

Therefore, in our exemplary embodiment, the foremost “components” are people—the rightful people!

The rightful people, namely Bridespace of the 1,44,000 citizens shown in FIG. 3 is arrived, who are dispersed worldwide, by passing the initial Christocratic-space Service profiles, namely all people who have already subscribed or at least given accent or acquiesced to the Christocracy, through the Service Selection Policy's Implementation Process as shown in the Flow-chart represented in FIG. 3.

The process shown in FIG. 3 is arrived at based on the following analysis:

First off, it is a given that macroeconomic difficulties—which is the scope of any Governing System—need to be addressed by macroeconomic remedies. But secular men can provide remedies, if any, at the most, for a nation, because their broad vision can extend only so far as their own country's borders. A case in point is climate change. One of Britain's most eminent scientists (lord May), who is an atheist, has recently said that the world may have to turn to religion to save itself from catastrophic climate change. He said, “A supernatural punisher maybe part of the solution.” But an inanimate Super-Computer cannot be a natural punisher let alone a supernatural one! Therefore, global polity is in the purview of God alone and not some G-7 or G-20 states, in which case it would only be hegemony. Hence, providing a legitimate and yet viable global polity of morality, falls squarely in the plates of God's elect.

Also W. T (Ted) Hind postulates: “Since societies cannot avoid legislating morality, then societies should legislate God's morality.” So who is this God of the elect whose morality forms the basis for legislation? Thus says the Holy Spirit: “As for God [of the Bible], His way (the morality embodied by Jesus Christ) is perfect; The word of Yahweh is proven/tried [with the life, death, burial and resurrection of Jesus Christ as attested by a cloud of witnesses]; He is a shield to all who trust in Him.”

Jesus, who cried to the Father before His crucifixion, “Yet not as i will but as You will”, kept the spirit of the Law of God, while His contemporaries were wishfully applying the letter to suit their own selfish ends. Therefore, self-righteous people even though they are producing GOODS & SERVICES (holiness) without which in the first place no one will see the Lord (Hebrews 12:14, The Bible) need to be filtered out and kept in Christocratic-space. It follows then that the Law of the indwelling Spirit of Jesus is what needs to be legislated, with the Acts of the Apostles—Chief Apostle being Lord Jesus Christ Himself—becoming the Precedent. Therefore emphasis shifts from legislation to the legislating body i.e. the Bride of Jesus Christ which also does the interpreting. The Church/Bride alone is the common denominator that every country has. She alone can orchestrate care, globally through her Ambassadors.

Thus, in drafting the specifications for the Users in such a Christ-headed User-centred and ranked Support System, for instance in the domain of human government, we would have: one who is “poor in spirit”/“meek” (Matthew 5:3, 5, The Bible); or “humble” (Matthew 18:1-4 NASB). That is, someone who is submissive and has proved himself to yield to good governance and authority himself. Which narrows our search to a Christian who has humbled himself to such an extent that he died to self-will and was born again in Christ Jesus (Be Born Again, Caleb Motupalli, Skyfeast.org, 2008). Thus we have two broad “spaces”:
a. Bridespace of Christians (born-again ones) from all over the world, who have produced holy GOODS & SERVICES as the Rightful people component spaces, namely blocks 5A, 17, 21, 23 in FIG. 1B and FIG. 1C:
Unlike in the days of Jesus where He was the sole anointed, to be Christ today means to be enjoined with a corporate/conglomerate entity where every member is anointed or indwelt with the Holy Spirit. “The Lord (today) is the Spirit” (2 Corinthians 3:17-18, The Bible), who pervades and rules in and through the Bridespace. To head the Bridespace of the body of Christians, spaces 9s shown in the left side in FIG. 1A of 61 in FIG. 1C is for twelve Apostles 37s of FIG. 1A in the Bridal Metaphor Environment Control System 5B of FIG. 1A of the geographic east. And similarly for those in the west. Spaces for Prophets/Priests, Teachers, Administrators etcetera in that order as found in 1 Corinthians 12:28, The Bible, who have willingly become slaves to righteousness through the Spirit as mentioned in Romans 6:19, 22, The Bible, viz. the twenty-four Apostles/Elders of Revelation 4:4, The Bible, are present in the Bridespace block 21 of FIG. 1B and FIG. 1C of the Christocratic Necked Service Oriented Architecture. And Christ who will manage all our lives as the Lord or Life Manager 5 shown in FIG. 1A, will rule the world through the Super-Apostle space (eThrone) 5A of FIG. 1A and FIG. 1B, who has been kept in-charge of the Lord's household or Bridespace as mentioned in Matthew 24:45 of the Bible. The Apostles are not Kings but are Ambassadors because they are in the world but not of it. They are citizens of heaven, where Christ is King and who rules through His Spirit that indwells them. And to serve the Apostles is the Super-Apostle space (eThrone) 5A of FIG. 1A, who is possessed by the Lord 5, who is the Spirit as mentioned in 2Corinthians 3:17 of the Bible. Thus God (Spirit) will be shown to manifest as the Head of the Super-Apostle, and the Super-Apostle will be shown to manifest as the head of all Man, and Man as the head of Woman as mentioned in 1Corinthians 11:3 of the Bible.
b. Christocratic-space blocks 6, 15, 19, 25 shown in FIG. 1B and FIG. 1C
These consist of not only all those who accent and acquiesce initially but are found unacceptable for Bridespace, but also all those who will subscribe to the rule of the Lord/Super-Apostle/Ambassador, after the fact. That is, after Christocracy comes—after the visible manifestation of Pan-Environment Super-Cyborg/Christ takes place, with 1,44,000 members united to the Lord 5 shown in FIG. 1A—Top Sectional view—in the Upper Pyramidal blocks 5A, 17, 21, 23 shown in FIG. 1B.

### Development of Necktie Personal-Extender/Environment-Integrator as Shown in FIG. 2

Targeted design while exploiting the capabilities of the essential human beings makes good design and economic sense because it is easier to change technology at the design stage than it is to produce humans with unprecedented capabilities at a later date. In order that the machine also known as Computer, works toward extending the human's mind as well as the members of the body beyond their conventional boundaries, rather than replacing them, the present embodiment of the invention is a reinventing/recasting of the machine/network through “Black-box Modernization technique”, as a Necktie Personal-Extender/Environment-Integrator. Since the hardware for the data processor is very flexible in terms of the configuration it takes, it lends itself perfectly to Black-box Modernization technique. The hardware for the Necktie Personal-Extender/Environment-Integrator apparatus is ubiquitous in that it is located anywhere on the body depending on the application it is used for. Individual level “Necktie” apparatuses for designers is shown in FIG. 2 that consists of a pocket data processing device 18 connected to a global network with handwriting, speech, gesture and image synthesizing/processing software, a camera 10 (optional) on the forehead, a ear-phone 16 with microphone 14 (optional if camera is present) and a projector 12 (optional if there is a display for the data processor). Cyberspace 21 is superimposed over Meatspace 20 in multi-media.

It cognitively represents an Extender of the Self through the Necktie Imitation and results in a high bandwidth interaction for those who need to learn and member the Body with a Christocratic Necked Service Oriented Architecture (described in Step 4) or be the said Pan-Environment Super-Cyborg.

The way a Persona is augmented by means of the said Necktie-imitating Personal-Extender/605 Environment-Integrator is dealt subsequently.

Going a step further now in this black-box modernization technique, Distributed Object Technology and its middleware are providing for us the necessary integration technology for collating/integrating the environment elementally, while the browser and the web are providing for us the necessary extension technology. So in effect we have a Global Necktie Personal-Extender/Environment-Integrator. In other words a Global Cyborg (machine-man) can be realized and manifested because the Necktie Personal-Extender/Environment-Integrator metaphor environment “wraps” the newly assembled system with new and unexpected concepts as enumerated in the Advantages of the “Necktie”/“Fine-Linen-clothes”.

Thus the Necktie Personal-Extender/Environment-Integrator is an extension of self to the far corners of the world by means of a global network, while also serving to integrate into self all types of metaphor objects of the environment.

Virtual Wrapping of Membership with Clean-Linen Clothes Imitation

The Bridespace of the Biblical invention, which is restricted to primarily Meatspace, is without a proper shape or structure except for the supposed inbuilt organizational hierarchy. The Black-box Modernizing technique is once again used here. The Biblical symbol namely, Clean-Linen clothes Metaphor of Revelation 19 or the Wedding clothes of Matthew 22, that is “wrapped” around the body of Christ is their GOODS & SERVICES via the Network (Internet). Consider Revelation 19:8 NKJ Bible: “Let us be glad and rejoice and give Him glory, for the marriage of the Lamb has come, and His wife has made herself ready, And to her it was granted to be arrayed in fine linen, clean and bright, for the Clean-Linen is the righteous acts of the saints.” Consider also 1 Timothy 2:9-10 NAS Bible: “Likewise, I want women (including the Church, which is seen as the Bride of Jesus Christ) to adorn themselves with proper clothing, modestly and discretely, not with braided hair and gold or pearls or costly garments but rather by means of good works, as is proper for a women making a claim to godliness”. Also consider “without holiness (good works), no one will see the Lord” (Hebrews 12:14 NIV Bible). These verses mobilize the professing Church unto good works, which translates into Holy GOODS & SERVICES of the eThrone/e-neck/e-donkey/Apostles for Christ and then the Apostles in-turn clothed with the Bridespace's GOODS & SERVICES (Matthew 21:7-8). The Holy GOODS & SERVICES or a Clean Linen Clothes Imitation for clothing the worldwide Bridespace is obtained by interconnecting in love, synergistically (giving the perception of overlaying) all the Clean-Linen Environment-Integrators (apparatuses) of Saints. This translates into a global network of GOODS & SERVICES supplied or procured by them. It signifies that the Bridespace is ready for her wedding with her husband—to be “tied” to Him.

A plurality of apparatuses, interconnected globally and synergistically, which translates into Holy GOODS & SERVICES over Bridespace blocks 5A, 17, 21, 23 that each member offers together with the members themselves, constitute a means for making a Clean-Linen Imitation, which serves as clothing for the Bridespace or Governance Support-space. But there is NO clothing, representative of Governed GOODS & SERVICES over Christocratic-space blocks 6, 15, 19, 25 as shown in FIG. 1C. This means that the governed do not have the said Neckties but operate in Meatspace with those who do, namely the Bridespace.

### Structuring the Christocratic Necked Service Oriented Architecture and a Lord's Necktie Personal-Extender/Environment-Integrator 5T as Shown in FIG. 1C:

The global network or the Internet of today can be likened to the Spirit of God, who, in the beginning, “was hovering over the face of the waters” that had become the waters and the land (Genesis 1:1-9). In other words, there was no concentration of the Spirit of God in any specific place—all were necessary and all were about equal, at least in the minds of most socialistic democrats of the world. The metaphor here is one of a flat bedded grass field or prairie lands. The network has made the world flat (Thomas Friedman). The world is like a blob that is amorphous and therefore anarchic with n-entropy.

But the glory or exaltation (height) that is to be revealed in man—the perfect man, which is Christ—is not to be limited to that of a “grass plant”. His self today extends throughout our environment (natural, built and social). In other words, there is a flow of the abstraction called “love” (service) throughout the environment, so to speak, “to the ends of the earth.” According to the 80/20 rule of the “One Minute Manager”, as this flow of service is coming to “fluid” earth, 80 percent from top-down to those 64 percent of people below in the bottom upright pyramid as well as 20 percent from bottom-up to those 16 percent above in the top inverted pyramid in FIGS. 1B, 1C. In this manner approximately 80 percent of the earth is covered with this flow of Service. But the reciprocal flow abstraction called “respect” (compensation/remuneration) is not yet realized in the form of empowerment of God's elect. If 100 percent of the earth is to be covered with this Good/Service of “love” then appropriate reciprocal flow must be forthcoming and maintained.

The “kill-and-grab” axiom of the “Spider Web Metaphor Environment Control System” a.k.a. World Wide Web may be appropriate for some corporations to command “respect” and therefore could be used if the “evil” connotations in the name were removed. A better axiom—advantages of which are covered later—one of both extending self and on the other hand integrating environment into self is provided by the Necktie and Clean-Linen metaphors, which are suitable for high-ended works involving Christ.

As shown in Step 1 (Phase 1), some minimum number of candidates in Bridespace and Christocratic-space in the Christocratic Necked Service Oriented Architecture are arrived, in order to press into service. Now comes the step of getting the rest of the world and other elements in the natural and built environment to acquiesce to Bridespace.

In order to understand how the “Necktie” apparatus, Clean-Linen Clothes Imitation with the said architecture works as one system, take for instance all members of a human body. Assume they were NOT assembled as in the erect posture of a real man. That is, all members together, which constitute the body, were only a mass of jelly, having no shape or form. The body was only so tall as each cell's height. In other words, there is no rank and file. The body is flat on the ground like a blob. Now draw a parallel with this blob and the global network. You will find that indeed the network is like the blob—flat. The fact that “the World is Flat” is well documented by Thomas L. Friedman in his book. As said earlier in the Background, everyone including big MNCs to governments are levelled to that of a single individual, who can create havoc in their midst with the Network-is-the-Super-Computer.

Now (Phase 2), a candidate who has an apostolic commission from God can now take the “Necktie” and begin to use the same Implementation Process of FIG. 3 for each Subscriber and integrate by standard Object Oriented Analysis and Design techniques and order by ranking, one member with another member or a plurality of members in a third member of the body into the already wrapped-up (with Clean-Linen clothing) initial Subscription/Accentor-space. Using minimum configuration of the Necktie Personal-Extender/Environment-Integrator, an advanced form of Bridespace and Christocratic-space is obtained. Then the rest of the citizens of the Worldspace/Environment-Space 67 shown in FIG. 1C are brought directly or indirectly under the authority of Christ/Lord/LifeManager through evangelism and other peaceful geo-political campaigns such as the macroscopic evangelism by the Pope or by televangelists like Dr. Billy Graham. Those who believe the message (partly contained in this document itself) would also Subscribe and take part in the Bridespace and some who do not believe would at least give Accent and the rest of the world more or less are expected to Acquiesce given the security issues of having Mode 0 Embodiments (explained later) floating around.

Thus all citizens of the world, it is contemplated, are one-by-one integrated into either Christocratic-space or Bridespace/Bodyspace in the eastern and western flanks 64/61 and 65/62 respectively or wherever the candidate may be.

Bridespace is further structured in the following manner: The system of human government such as those found in the Church as stated in scripture, have a hierarchical architecture built-in as mentioned in 1 Corinthians 12:28 and 1 Corinthians 11:3 of the New American Standard Bible that is neither too heavy at the top nor too flat at the bottom for comfort. This kind is suitable for everyone to take their own initiative at work. Moreover this is just the kind of architecture that can be built by integrating Cyberspace and Proximity Meatspace by removing all the redundant bureaucracy, even as User's Persona, specifically his Intelligence, is augmented with Cyberspace Integration at different levels as shown in the Operation of the Necktie Personal-Extender/Environment-Integrator. Therefore, exploiting that built-in hierarchical structure, each member of the Church (the called-out ones) is arranged after proper Assessments in a synergistic Christocratic Necked Service Oriented Architecture as shown in FIGS. 1B, 1C, made possible with 1) Necktie Personal-Extender/Environment-Integrator provided for each member/citizen, and 2) lord's/Apostles Necktie Personal-Extender/Environment-Integrator at each level under consideration. (As for other GOODS & SERVICES in the Environment-space 67, they are identified with the aforementioned apparatuses and accordingly handled by the members through automatic, semi-automatic or manual processes.)

The relative sizes of each of the blocks indicate the tapering requirement for resources in those blocks.

In the top pyramid namely in 5A, 17, 21, 23, members are ranked in that order chronologically. Block 17 of FIG. 1B and FIG. 1C corresponds to the Bridal Metaphor Environment Governing System 5B of FIG. 1A—Top Sectional View. Bridespace's Governance Services block 21 consists of services to handle governing of the Christocratic-space's Governed Goods & Services in the bottom Pyramid in a decussated fashion; that is, from east to west and from west to east from top to bottom. Business Portal block 23 takes care of Interactions with the outside Worldspace/Environment-space 67.

The exemplary embodiment has an equation where the least in Bridespace is greater in rank than the greatest born of a woman, (Matthew 11:11 NAS Bible) who is presumably in Christocratic-space block 6. He is identified through the same set of assessments used for identifying Bridespace. He is the one who comes through till the end except when it comes to “The witnessing of the Holy Spirit” query in Flow chart shown in FIG. 3, where he fails. He is immediately earmarked to be under Neck 5A (e-Donkey) and reports directly to him. Neck 5A corresponds to Super-Apostle's-space, eThrone or Governor-Space. Registry Service block 15, communicates through Messaging block 19, which uses the Lord's Necktie End 27 for serving in West Bridespace's Governance Services 11, and Lord's Necktie End 29 for servicing in the East Bridespace's Governance Services block 9, with GOODS & SERVICES in block 25. These corresponding services are ranked in that order from top to bottom chronologically.

So now, if one were to make a Lord's Necktie Extender/Environment-Integrator for the Ambassador/Super-Apostle/Governor 5A who is indwelt by the Lord or Life Manager 5 shown in FIG. 1A that is the Mode 1 Embodiment (where Users are the Rightful Users) of this invention, it would need to encompass everything in the whole environment because the Lord Jesus Christ is Lord of all. Everything in the environment should work for Bridespace and Bridespace should be able to serve vice versa with Governance Services everything in the whole environment. The reason being, to be greatest is to be a servant of all—a prime minister/servant. In other words, the greatest in Bridespace is figuratively the least in Bridespace.

Therefore, the present invention has two Pyramids, one inverted, which is—all those born of God (John 1:12 NAS Bible)—the Bridespace blocks 5A, 17, 21, 23 shown in FIG. 1B, and a second upright Pyramid, which is of the Christocratic-space—all those born of woman blocks 6, 15, 19, 25 shown in FIG. 1B. FIG. 1C also shows the placement of the greatest born of God block 5A, who is the least in Bridespace, and the greatest born of a woman block 6 as per Matthew 22:44 of the Bible.

### Decussating the Pyramids

The Neck 5A, who has the highest rank in the Architecture, does not have dominion over the whole body/world/environment as of yet. The control is achieved by first using a hypothetical weak member (weak in terms of what it really takes to control a whole mankind) at the neck for now. Thereby the strength of the members in the head (Bridespace) is magnified to the Christocratic-space in the weakness of the Neck (2 Corinthians 12:9 NAS Bible). For, the Lord Jesus Christ's grace in the form of Governing GOODS & SERVICES of Bridespace—Fruit of the Spirit (Galatians 5:22-23 NAS Bible)—is sufficient for him (Neck).

Now honor needs to be given to whom honor is due, tax to whom tax, and custom to whom custom, and fear to whom fear (Romans 13:7 NAS Bible). Therefore, secondly, the two Pyramids are taken through the Phase 2 of the Filtering process. A custom set of assessments are applied respectively in each of the Pyramids including for those who join in later, in order to determine if those persons belong there in the first place and if so where they have to be placed. Custom assessments are used for the purpose of ranking/grading for appointment in the Pyramids of the Christocratic Necked Service Oriented Architecture.

Each member who is called-out of the world who has had a born-again experience, such as one of having gone through the process mentioned in “Be Born Again” at Skyfeast.org written by the present Inventor, and having come out through the Service Selection Policy's Implementation Process, is deemed to be in the Bridespace and is assessed by custom appraisals, namely: Wagner Modified Houtes Questionnaire, Personality Type Assessment, Leadership Style Assessment, Aptitude tests, Domain Experience assessment in order to place him in the Bridespace. But other assessments such as S.H.A.P.E, by Rick Warren of Saddleback Church, CA, USA, can also be used. After this assessment he is virtually lowered by appointment in the Bottom-up Pyramidal Building Blocks 23, 21, 17 of FIG. 1C and FIG. 1B in that order towards the centre. As for the rest (Christocratic-space) each is raised in the Top-down Pyramidal Building Blocks 25, 19, 15 of FIG. 1C and FIG. 1B after other custom set of complementary assessments are made.

In order for the Neck 5A shown in FIG. 1A to maintain its control of both the body (Christocratic-space) and the head (Bridespace), the head or the Top Pyramid is split into two, “left brain” (presently shown in the Consumer mode), which pertains to the geographic east Bridespace 61 and “right brain” (presently shown in the Servant mode), which pertains to the western Bridespace 62 both of which serve either of (XOR) the two roles: 1) Bridespace Controlled Governance Service Servant 11 mode over a Service-end 27 of Lord's Necktie Personal-Extender/Environment-Integrator and 2) Bridespace Controlled Governance Service Consumer 9 mode over a Consumption-end 29 of Lord's Necktie.

Similarly the Bottom Pyramid is also split into two halves, Eastern Christocratic-space 64 and Western Christocratic-space 65 (both of which serve either of (XOR) the two roles: Subordinates 39 (twelve in number—Apostles or subordinates to Super-Apostle) exercise control through Lord's Necktie End 27 on Governed Servant 7 in Christocratic-space. And Subordinates 37 (twelve in number) exercise control through Lord's Necktie space 29 on Governed Consumer 13 in Christocratic-space. Further, since the neck—Governor 5A—is a weak vessel with pressures from all over for attention, it is enabled to engage in “cross-trading” (“Insider-trading,” legalized by the Lord Jesus Christ—Luke 16:1ff) by decussating (through information hiding—abstraction and encapsulation) the two inverted pyramidal halves of the brain (Top Pyramid) with the two upright pyramidal halves of the body (Bottom Pyramid) 75 percent of the time (i.e. 75% of all events), to stay on top of things as shown in the crossing of the Service-end 27 of Lord's Necktie, and the Consumption-end 29 of Lord's Necktie.

The decussating pyramidal architecture can also be likened to a river with streams joining the river on the upland and the tributaries in the lower end of the river where it merges with the ocean, with the middlemost member (Service Broker at Neck level of the Conglomerate) wielding the most power by being in the specific level in the architecture shown in FIG. 1C. Seventy five percent of the Conglomerate/Corporate (Lord's) Service-end 27 and Consumption-end 29 shown in FIG. 1B are decussated at the Conglomerate's/Lord's (with a Capital ‘L’, denoting Lord of lords) Service Broker for the Conglomerate and similarly, at Corporate's Service Broker for Corporate's (lord's) respectively, for the purpose of giving control to the righteous and “poor in spirit” (i.e. the despairing-righteous, in keeping with the Sermon on the Mount of the Lord Jesus Christ—Matthew 5:3,6,10 The NAS Bible) as they may not have the requisite qualifications to “neck”/head such a cyborgic body. And wherever the river flows there is produce.

Super-Augmenting Persona on eThrone Through the Bridespace & Bridal Metaphor Environment Control System 5B Shown in FIG. 1A

While collaborating in the teleworking and telegovernance environment of the Christocratic Necked Service Oriented Architecture, entropy is reduced through the presentation of only 7 plus or minus 2 units of information in the form of soft or hard units to the immediate Ordinate Human Component at any given time or at any given node except when he is sleeping or taking rest. Information from subordinates/superiors/Super-Augmented Persona is taken as sense perception and insight. Thus the said n-entropy is reduced, whereby it enables fewer resources to be present as we come closer to neck level from either the top or the bottom.

Notice that there are 24 Apostle Spaces, which is more than 7±2 spaces in Bridal Metaphor Environment Control System 5B. The reason being that explicit control is not so much necessary with them as they are working by choice—they have bent their knee before the fact of the manifestation of the Super Cyborg.

The Super-Apostle space (eThrone) 5A shown in FIG. 1A is first augmented by His own personal Necktie-imitating Personal-Extender/Environment-Integrator and then He is further Super-Augmented by the Lord's Necktie Personal-Extender/Environment-Integrator through Lord's Necktie Ends 27 and 29, which are simply referred as Lord's Necktie 5T shown in FIG. 1C.

The Lord's Necktie Personal-Extender/Environment-Integrator, together with the Christocratic Necked Service Oriented Architecture, the Augmented Personae in Bridespace, and Super-Augmented Persona at the Neck, enables the Rightful User to manifest as a Global Cyborgic Conglomerate Christ/Pan-Environment Super-Cyborg for global governance as we will see in the Operation.

The plan for “The Marriage Supper of the Lamb with His Bride,” reduces the invention to actual practice.

### Operation

### Operation of Necktie Personal-Extender/Environment-Integrator to Augment Persona of an Individual

In one embodiment using common Computer Vision techniques, which are available in the open source, the camera, which may be placed as portable headgear or otherwise conveniently on the body, recognizes all what we see with our naked eye as well as Cues, which are either given to it through encoded tags, placed on user's fingers or in the user's proximity with respect to: for instance 1) “Pointing,” with the index finger tag; 2) “Grabbing,” with two fingers' tags; 3) “Capturing,” with four fingers' tags, objects real or virtual. The software program processes the video stream data captured by the camera and tracks the locations of the colored markers in N-Space with respect to the Camera location. The movements and arrangements of a set of tags are interpreted as specific encoded sign language that act as interaction instructions for a mini Projector (which may also be placed on the body or otherwise) to project visual information from Cyberspace on surfaces in User's Proximity Meatspace—say on a book that he is reading or on a wall in front of him or even on other representations of his Meatspace remotely held on other displays/holograms. The processing of the Extender itself may be done in a handheld electronic data processor. Thus the User's Proximity Meatspace is layered with pertinent “smart” Cyberspace and thereby it is augmented. As for the Cues they can be other media as well, including Audio. Whatever is spoken is picked up by the data processor and “smart” cyber-audio is generated for the User.

Operation to Manifest Embodiment Mode 1A—Pan-Environment Super-Cyborg/Christ with Super-Augmented Persona (i.e. a Christocratic Kingdom-in-Dispersion with an eThrone)

Bridespace's Subordinate Servant 39 within Cyberspace Super-Augmented Lord's/Prime-Ordinate's Persona 5B shown in FIG. 1A by means of Necktie Personal-Extender/Environment-Integrator 11 Publishes available Services 33 shown in FIG. 1B to Registry 15 through Super-Apostle's space 5A. After Bridespace's Subordinate Consumer 37 “Finds” a Service 33 offered by a Bridespace's Subordinate Servant 39 vis-à-vis the Super-Apostle's/Governor-space (eThrone) 5A, Bridespace's Subordinate Servant 39 is called upon through Ad hoc Contract/Interaction 42 mediated by Interaction 44 shown in FIG. 1B, by the Governor-space (eThrone) 5A within Bridespace Super-Augmented Lord's/Prime-Ordinate's space 5B shown in FIG. 1A, Bridespace's Subordinate Consumer 37 for Service 33 shown in FIG. 1B. Bridespace's Subordinate Servant 39 Serves Bridespace's Subordinate Consumer 37 through Messaging Services 19 over a Conglomerate/Corporate Service-end 27 of the Lord's Necktie, an Extender Service 33 by Governed Server 7 who interacts 31 with Extender Client 35 of Human Consumption Worker 13 who works for Bridespace's Subordinate Consumer 37 over a Conglomerate/Corporate Consumption-end 29 of Lord's Necktie.

The result is a new synergistic embodiment, which when extrapolated across the Church-in-dispersion will have glorious features of those depicted in Jesus Christ's Transfiguration as mentioned in the Holy Bible (Exodus 33:17-23; John 1:14; cf. “Be Transfigured” by the present author, Skyfeast.org) to denote the Holy Goods & Services that He offered with the sacrifice of His body. The Super-Augmented Persona for the Super-Apostle is built with a Bridal Metaphor Environment Governing Module/System 5B as shown in FIG. 1A. In other words the blob will take shape and will be erect like a Global Cyborgic Conglomerate Christ or a Pan-Environment Super-Cyborg with a Christocratic Necked Service Oriented Architecture as shown in FIG. 1C.

### Operation of how N-Entropy is Mitigated as Shown in FIG. 1D

FIG. 1B showed the operation as it relates to only one level, namely the Prime-Ordinate level. In FIG. 1D Sub-ordinate Manager 5M of Bridespace who represents Super-Apostle 5A in the world (Christocratic space), is seen handling 7±2 jobs/units. But this principle is extrapolated to cover the whole environment with each unit via a sub-ordinate or a sub-system handling yet another 7±2 jobs/units and so on. So at each level the ordinate is expected to handle only n number of hard or soft, Proximity Meatspace or Cyberspace based units of information (whichever form it takes at that instance) below himself or above himself as shown in FIG. 1D as the case may be with respect to especially Christocratic-space, where n is equal to 7±2. Thus the whole environment's n-entropy is handled with the Pan-Environment Super-Cyborg for viable global governance and life management.

### EXAMPLE

Take for instance a scenario where it is implemented: a “Necktie-imitating Neurosurgeon's Personal Extender/Neurosurgeon's-domain-integrator (collator)” for a Neurosurgeon's team where he is the Pan-Environment Neurosurgery Cyborg:
1. A person has a fatal accident in a remote village in India. Has not enough money to afford a Super Specialty Hospital care. Christian Surgeon in USA is willing to operate and a neurologist in UK is willing to diagnose with his Necktie-imitating Neurologist's-Extender/Neurology-domain-integrator.
2. Neurologist's diagnostic enterprise extended by his “Necktie” is spread across the globe. Patient brought to nearby diagnostic lab/operation theatre located near patient's village and the Neurologist sitting in UK diagnoses and sends report to Neurosurgeon in USA.
3. Neurosurgeon operates on the patient with his “Necktie” sitting in USA.
4. Patient pays part of the bill.
5. Another part is paid by Managed Care Company which has its own Necktie-imitating Corporate Extender/Managed-care-domain-integrator.
6. Etcetera.
7. All within the framework of Christ's “Necktie” Governance with the eThrone.

Note: The phrase “Operating System” is at best a feature of the self-serving, so called “thinking machine” and is therefore not found suitable for the present invention. Nor is the phrase “Control System” even though man in his perfect state, needs to be and will be on “top” of everything. The word “Environment” is used in order to not come across as demeaning because as said earlier the present embodiments of the invention, comprises of humans, who will be membering the system. However, there are certain controls delegated to “Autonomic Digital Nervous System,” a.k.a. “Operating System” for the purpose of executing grunt (factory) and automatic functions for which claims are also made as part of the whole.

### Additional Embodiments

1. Mode 0
a. Description: Independent Cyborgs (Human-machines or Humans with a Personal-Extender/Environment-Integrator);
b. Operation: Built using a Personal Extender, he moves freely in N-Space under no authority—a lawless one furthering anarchy;

2. Mode 1A: (already discussed in detail above)

3. Mode 1B:
a. Description: Global Cyborgic Conglomerate Superhuman;
b. Operation: Built using general assessments similar to Components as described in Mode 1A, but with cooperation possibly from the Anti-Christ Members;

4. Mode 2A and Mode 2B (Surgically Implantation of Mode 1A and Mode 1B Extender respectively):
a. Description: Necktie Personal-Extender/Environment-Integrator of Mode 1 with the virtual component of the Proximity Meatspace Augmented-Integrated Cyberspace is concealed in the body specifically the vision in the eye and the audio in the ear, etcetera;
b. Operation: The build is partially by surgically implantation.

5. Mode 3:
a. Description: Other kinds of quasi Necked Service Oriented Architectures either of other religions or of secular nature.
b. Operation: Built using other kinds of policies.

### INDUSTRIAL APPLICABILITY

The Necktie Personal-Extender/Environment-Integrator, the Bridal Metaphor Environment Governance System with eThrone and the Christocratic Necked Service Oriented Architecture (CNSOA) will have wide acceptance in the Church because parallels have been drawn (as also with a hypothetical marketing ad) between the said metaphor objects (GOODS & SERVICES) and biblical, prophetic symbols. The Necktie Personal-Extender/Environment-Integrator can be a personal wear, which can be profitably used by a person to not only extend himself (as described) and integrate with the kingdom of God/Environment in the supply & procurement chain, but also be used as a means to establish a divine relationship with God and inherit eternal life for the corporate Bride of Jesus. The Necktie and Fine-Linen/Clothes (Holy Goods & Services) can correspondingly be thought of as wedding garment and corporate wear. The Bridal Metaphor Environment Governance System with eThrone can be used for e-Governance by multi-national corporations (MNCs) like the Church where n-entropy is handled at every level below and above, and the same (MNC) can be structured like the Christocratic Necked Service Oriented Architecture for viable global governance.

### ADVANTAGES

The most important advantage of the eThrone is manifesting the Pan-Environment Super-Cyborg (Wedded Avatar of Christ) for orchestrating global governance to bring justice, peace, and wealth to the rightful people by mitigating entropy at every level in the architecture and thereby arresting global anarchy.

The following advantages are in addition to that:

### Advantages of Using the Christocratic Necked Service Oriented Architecture (FIGS. 1B, 1C) by the Pan-Environment Super-Cyborg-Christ:

a. N-Entropy is mitigated at all levels thereby arresting global anarchy wherewith global governance is orchestrated to bring justice, peace, and wealth to the rightful people.
b. Global Governance is tailor-made for the rightful people, namely the humble of the earth, and control restored to them.
c. Being that the architecture makes viable distributed/integrated processing on a global scale, teleworking and telegovernance is made feasible. Thus making it a socially, economically and environmentally, a sound technology.

d. My embodiment employs more people than the Prior Art to do the same task, and perhaps giving more resting time for each individual. However, each individual is utilized strategically by placing each member/machine/corporate synergistically with respect to each other and therefore higher order problems are tackled. Thus it solves the problem of unemployment caused by Prior Art to a great degree;
e. Also to be noticed is the absence of a Service Contract as it was in the case of a Prior Art Service Oriented Architecture (“SOA”). The reason there are none because lengthy Service Contracts leaves out the human element in the transaction. Human element is especially necessary in finalizing the transaction. Therefore only an Interaction or an Ad hoc Contract is mentioned between the Servant and the Consumer. Standard Forms of contracts may or may not be used depending upon the magnitude of the Service.
f. Minimal information (7 plus or minus 2 units/bits) needs to be handled by the Service Broker at neck level or for that matter at any level. This is because entropy is reduced at every level and only insight in the form of sense perception is sent above or below, whichever is appropriate;
g. Hiding information by way of abstraction and decussating of the pyramids, enables the Super-Apostle 5A to maintain non-partisan politics and keep the body together;
h. The information economy of cognitively representing the Personal Extender with the Necktie imitation is quite substantial. It results in a high bandwidth interaction for those who need to learn and use the Christocratic Necked Service Oriented Architecture or be a part of the said Pan-Environment Super-Cyborg.

### Advantages in the Necktie Personal-Extender/Environment-Integrator for Manifesting Embodiment Modes 1A, 1B, 2A, 2B:

a. The Necktie Personal-Extender/Environment-Integrator through its metaphor environment results in high bandwidth communication and interaction (i.e. with high information economy) for the manifestation of all modes of embodiment. The “Imitating Real Life Object” invention namely, the Necktie Personal-Extender/Environment-Integrator has information economy for user learning to an extent that by itself it cognitively represents the following when placed in association with man and his built environment to manifest the Embodiments: In a sweeping motion, it can be thought of as integrating/incorporating all the heterogeneous members (metaphor objects) associated with a corporate body/bride and marry her to the head by means of first adorning with “Clean-Linen clothing” (wrapping by encapsulation—Black-box modernization technique mentioned earlier) the members with good works, the Individual (organism) and the Machine (Cybernetics) into one whole called Cyborg together with an Augmented Persona made manifest. Secondly, when all the members in our environment are similarly “clothed” and humanisticaly ranked through the said custom appraisal heuristics by exploiting society's value system—with Christ receiving the top rank for having laid down His sinless life for the world—and arranged as shown in FIG. 1C, the result is the new and unexpected Pan-Environment Super-Cyborg/Global Cyborgic Conglomerate Christ. While the fine-linen-clothes stand for the net-work, it “integrates”, “wraps” or “scrapes” all the levelled and subdued heterogeneous metaphor objects of personal domain/environment and subject it to the persona of each member. With respect to Christ, on the other hand, through a Lord's Super-Augmented Persona or Bridespace of the Christocratic Necked Social Architecture, it will also in turn extend His mind along with each member's at each level. Christ's mind is thus extended and the environment's metaphor objects integrated into Him. His body too is proportionately/infinitely extended, making Christ to whom every member's persona is subject to, supreme. God Himself being all-in-all since Christ Himself is subject to Him (1Corinthians 11:3). The “Necktie” not only marries (interfaces) the rightful users with their superiors and subordinates (including objects in the natural, built and social environment) but also manifests the whole by “tying” them (or marrying them as in the oriental tradition), while maintaining the scope of the incorporation to the desirable objects through human component intervention and yet subjecting the rest to the conglomerate/nation as such through each member's capacity/authority/powers vested in them.
b. All the while it keeps the machine, namely, the cybernetic component, when it comes to individual's Persona, and Servant/Client Cyborg 7+33/13+35 in FIG. 1B, when it comes to Lord's Environment/Persona, subservient to the user;
c. Through the unique Necktie “wrapper” (Metaphor Environment) for the electronic data processing and communication system with accessories and peripherals, offers a perspective and a new meaning so much so that it is easily learned and operable in the mode of a class of Personal-Extender/Environment-Integrators (Prior art: Computer, Robot, Network-is-the-Super-Computer, etc.), which results in the synergistic structural manifestation of Global Cyborgic Conglomerate Superhuman or Christ. Synergistic structural formation takes place when each member/citizen is appraised with the aid of said Assessments and ranked and placed in their respective positions. Thereby each member's/citizen's profession/occupation/designation/etc (which is essentially the embodiment of his mind) is integrated with the body as in a typical Administrative System or a Human Resource Management System or an Enterprise Resource Planner. Now as the spirits/minds including the external data processor are fluids (flexible) by nature, they can be readily contained in an encasement or in our case, a wrapper. Therefore they are said to be integrated with the system and encased/wrapped to generate an embodied cognition (for learning and using) of a Global Cyborgic Conglomerate Superhuman or Christ. The said Cyborg is a Superhuman or a wedded avatar of Christ and not merely a group of people and machines put together because: to be Christ today means to be an Anointed Conglomerate, or everyone in the said Cyborg embodiment is said to have the indwelling of the Spirit or the Holy Word; where the words or other expressions of the mind of the professor, etc that have been integrated into the system are the synergistic spirit and synergistic life of the said Cyborg (cf. John 6:63 New American Standard Bible);
d. Compliments the user and cognitively places him in the neck position in the head-and-members-of-the-body hierarchical relationship, where members could be any cyber or real world subordinates or other autonomic sub-systems. This placement of Christ and the members of His body—the sons of God—in the hierarchy, forces the flat world as well to get restructured as shown in blocks 25, 19, 15 of FIGS. 1B in that order, and come under this hierarchy shown in blocks 17,21,23 of FIG. 1B in that order. Thus the world will no longer be flat. Since it is a placement in a human like corporate body, the structure allows for delegation of low level jobs to be processed below and high level jobs to be handled at higher levels;
e. When each user augments his Persona through Cyberspace Augmented Fleshspace, and arranged and aligned in like manner, it extends the power of the user/Cyborg so much so that an amount of synergy or Cyborg's insight is available to Users/Cyborgs, each according to their rank in the Necked Service Oriented Architecture;
f. It in-turn serves as an Integrator to empower and employ membership competencies/resources in an optimum and economic manner and also helps manage performance of subordinates;
g. Facilitates unlearning of the old paradigm, while enabling the learning of the machine/network as a Necktie Personal-Extender/Environment-Integrator. Since a necktie happens to be below the head, it therefore embodies a cognition of a Necktie-Imitating (hyper-extensible) Personal Extender with an Environment-integrating function;
h. Serves to implement a “participatory culture” and a Christocratic Participatory Meritocracy, where all are given their due, each according to their deeds with Christ Himself seated on the throne at the helm of affairs. For further reading, refer “Rapture & Implementing Christocracy NOW”, Caleb Motupalli, AgapeAmbassador.org, 2008-2010;
i. Aligns the membership with the head to orchestrate and accomplish with synergy any specific mega task/service or even minor tasks;
j. Serves to regulate the scope of each enterprise to be within a framework governed by Christ, while giving enough room for enterprise and expansion. This is because, both procuring and supplying aspects of the economy are handled by the architecture;
k. In combination with the necked Network-is-the-Super-Computer, which serves as the peripheral nervous system to virtually augment each member's real environment, the cross-section at the neck (The Bridal Metaphor Environment Governing System 5B shown in FIG. 1A Top Sectional View) serves as a command/information distribution/collaboration channel/environment to/with the various members of the body;
l. It produces a Lord's Super-Augmented Persona that enables the setting up of an eThrone for Christ for Christocracy. The synergy will be a giant leap for mankind to enter into an era of redemption of our bodies along with the rest of creation (Luke 21:28; Romans 8:23) and to come into the original perfect state that God created us in (except we will retain the knowledge of good and evil). This enables perfection or restoration of mankind through unity as prophesized in Hebrews 11:39-40;
m. Produces a theocratic economy by removing redundant bureaucratic objects and allowing all objects to focus on core and upper level competencies. A microcosmic case in point is the one proposed by Peter M. Foreman: The new system, which adopts a “total systems approach,” he says, “enhances the safety and economics” of the system as a whole;
n. With respect to the incarnate Christ first and then the user, it will lend the environment gracefully to object oriented principles such as abstraction, encapsulation (wrapping), inheritance and polymorphism;
o. Facilitates the incorporation of a diversity of subordinate perspectives for tuned diversity search;
p. Enables superiors in ordinate positions to break fixations on inaccurate hypotheses by having experts from diverse subordinate positions create mini-stories after reviewing partial data sets from the ordinate positions—diversity anchoring for crowd-sourcing;
q. It proposes a further research and development with infinite possibilities of extension on the one hand and integration/incorporation on the other.

### Disadvantages in Permitting the Manifestations of Mode 0 Embodiments:

With the global network environment still amorphous and unstructured, gives people having the ability to put together a Mode 0 Embodiment to extort free-labor through it and therefore Nth degree of Anarchy can result even beyond what is present today through prior art. This is more accentuated because this embodiment of the invention is bound to open up a pandora box. Therefore the Normative Constraint is very high on ethical grounds and thus ruled out in the Cross-Consistency Assessment of our morphological analysis, to arrive at a “solution space”.

### Disadvantages of Mode 1A Over Mode 1B:

Slow to implement and realize because it requires some amount of consensus among stake holders.

Disadvantages of Modes 2A/2B over Modes 1A/1B:

Costly and also perhaps inconvenient.

### Advantages of Mode 2A/2B:

Stealth.

### Conclusion, Ramifications, Scope:

According to one embodiment of the invention, an architecture is provided and it has the potential to give substantial dominion to the regulating body, that holy men, according to the principle of “whosoever has proven to bear the burden of many,” as well as able to feed or serve everyone alone need to “neck” and member that body. This is a desirable goal for all of mankind. For this to happen there need to be lords, and a Lord of those lords, and a LORD of that Lord—the Master of heaven and earth. In an egalitarian society that we live in, this may not go so well with many. But the egalitarians have a point or two. Firstly, according to Gandhi and other Socialists, it may appear as though there is only slight difference between all humans and therefore there should not be much disparity in wealth among them. But if one measures the effort it takes to cross a specific threshold to the next level after a point, it becomes all that much more difficult. God has created us all in such a way that only one should win the race, with others close behind. This, so that the leader is not too far up ahead, nor the followers too far behind to catch up, so that mankind can advance together concertedly. Secondly, the next point the egalitarians have is: most of today's lords who lord it over others do not deserve to be lords. They are actually anti-Christs (digital robber barons, etc.) subverting justice to the poor. Now cyberspace, if it is properly structured, has indeed the potential to bring these second wave illegal lords to justice by the third wave cyber-heroes. However, cyberspace itself is bogged down today by third wave cyber-thugs/anti-Christs. These anti-Christs are false Christs because they too are “word”. The leadership of the world in America made mistakes in Internet policy, and the digital robber barons were set free to do whatever they liked especially on the developing world's unsuspecting second wave heroes who will take the brunt of the spillover of bad policy, as the globalization wave of tsunamic proportions, progresses.

That the so called advanced forms of government, like the American democracy, have failed the people is evident. In the best political book of 2007, The Myth of the Rational Voter: Why Democracies Choose Bad Policies, Bryan Caplan writes, “Democracies frequently adopt and maintain policies harmful for most people.” Nicholas D. Kristof commenting on the book in the New York Times as published in the Deccan Chronicle 1 Aug. 2007 writes, “Churchill was right about democracy being the worst form of government, except for all the others that have been tried. Yet we should be able to respond to evidence of democracy's failings with something more than Churchillian resignation.”

But there is One, or rather One System, who has not failed man till today, and that is Christ, the Word/Spirit—who is incarnate in and through us today (John 10:35). When man sinned, he lost his dominion, which he otherwise enjoyed over all creation. Then Christ came on the scene and paid the just penalty for all those who put their trust in Him. But man continues to sin and brought upon himself the plagues of having women, money and machine to rule over him.

In an open manner, the power of the good/holy man is extended in Christocratic Meritocracy through the Christocratic Necked Service Oriented Architecture (CNSOA) where rightful humans, namely the humble and meek, play an important role in orchestrating the various services to accomplish a specific goal. Interaction between a Service and another Service in a specific classification is specified by humans in a relatively ad-hoc way but within the domain/class boundaries. Their position/rank in the bottom-up hierarchy is determined through holiness ranking received by a systematic customized assessments during corporate introspection at the marriage supper of the Lamb, which takes place at all levels of the architecture where the highest holiness rank being that of Jesus Christ's, the man who laid down His spotless and perfect life for all. To some holy men it is a Mental Prosthesis but to others it is a Necktie Personal-Extender/Environment-Integrator in order to bear the burden of many above them in the bottom-up-hierarchy w. r. t. those above the neck and a top-down hierarchy w. r. t. those below the neck. As said earlier, since the present architecture has the potential to give substantial governing powers to the Regulator/Super-Apostle 5A at the neck, only holy/godly/good men should “neck” and member the regulator, since “it is religion that makes man humane”—Late Y. S. Rajsekar Reddy, Chief Minister of Andhra Pradesh. Therefore, we must include godly/holy/good men in the system design and specification, right from the start as partially stated by Captain Peter M. Foreman. The specifications for a holy/godly/good man are found in the Bible. The specification in its simplicity, states that the “first” (prime-minister who is able to feed all) need to be one who is “least”—a “the servant of all”—who has humbled himself, etcetera. Then arming/enthroning him with the “double edged IT sword” namely, the Necktie Personal-Extender/Environment-Integrator becomes a matter of committing to prayer, them that have the Holy Spirit's commissioning for holy offices. In other words, they have been assessed to have respective individual S.H.A.P.E.s, where S stands for Spiritual Gifts, H stands for Heart and A stands for Aptitude, P stands for Personality, and E stands for Experience.

After assessments are made, the well acknowledged holiness standard namely, The Bible (or The Word of God) as summarized in these articles could be used to rank the members:
1. The Lord Jesus Christ's own words, “Whoever wants to be first should be the servant of all.” (Note: To be servant of all, one must be able to serve all, as well as prove himself to be truly humble with all, which means giving each one their due);
2. “Rediscovering Holiness” by Dr. J. I. Packer;
3. The 12 Marks of Holiness by J. C. Ryle
4. Evidences of a Humble Heart by Brent Barnet

As slaves of righteousness (Romans 6:18) we ourselves, the users in the Christocratic Dominion Architecture (i.e. the CNSOA), want to become bond-slaves in the chain of that command mentioned in:
a) 1 Corinthians 12:28-31, which is with respect to Apostles, Prophets, Teachers, Pastors etc as ones in-charge of the stewardship of the body of Christ;
b) 1 Corinthians 11:3, which is with respect to God, Christ, and every man and his wife;
c) Philippians 2:9-11, (that every knee bowed and every tongue confess that Jesus is Lord) which is with respect to Christ, everyone in heaven and on earth, to the glory of God the Father;
d) Genesis 1:28, which is with respect to mankind, living things and all non-living things in our environment

And thus the lost dominion could be restored to whom it belongs!

For those who have been enlightened and tasted the heavenly gift, the Word of God is more than a law of nature. By the sense of guilt—which, in the words of Theodor Reik, is the hallmark of any civilized humanity—we are constrained to order our steps in accordance to the Word of God/Law of love, whether we are consciously aware of it or not.

Even the Economist magazine with a cover story on April 2006 showed that Soft Paternalism, which is here shown can be realized through the said Christocratic Architecture, is the answer to today's uncontrolled, reckless and fast paced living. And I believe that it is also the answer to many corporate and national ills, including terrorism, whether they are economic or military. Soft Paternalism is not only the answer but that a total commitment alone rather than a flirtatious attitude would yield desirable results. Therefore a total solution approach rather than a point solutions' approach is maintained. In considering a viable standard for all matters of conscience (sense of guilt) for the purpose of arriving at the semantics of the system, the following definitive criterion is used:
Has anyone having kept all the laws of that particular scripture even though put to death was raised again from the dead, thus proving the integrity of the laws found therein? And is He also able to feed (serve) all either directly or indirectly giving each one their due?

Thus the knowledge of the Bible when transferred into the semantics of the said eGoverning system, it takes on a utilitarian status not only for life after death but life hitherto and after. Having established that there is a sense of guilt, apart from our other senses, automating the process of making saints becomes a matter of bringing the willing subjects under round-the-clock governance of the Soft Paternalistic Collaborative System or the said Bridespace.

We, who have tasted the love of Jesus, would gladly take His yoke upon us for it is easy and His burden is light. For, we will find rest for our souls (Matthew 11:28-30 New American Standard Bible).

### Additional Advantages of Mode 1A, Over Modes 0, 1B:

1. Justice, peace and wealth for the rightful;
2. Ethical and safe;
3. Enables the aspect of membership representation by a representative at the Neck through the Global Cyborg's Necktie;
4. Has the unexpected result of awakening/erecting, integrating and synergizing the “sleeping” fluid blob (Network/Internet) and its associated people together with other systems in the environment into a body;
5. The embodiment successfully solves a problem never before even recognized—the restoration of man to his original perfect state partially through such prosthetic means, which are in total the subduings of man;
6. Prior art is full of unsuccessful solutions that only tried to integrate the aspect of communication with information processing (namely Information and Communication Technology—ICT; Computer mediated communication; Computer Mediated Collaboration; etc), user with the machine (User Centred Systems); Computer with Mechanical system (Computer Controlled Manufacturing and other Numerical Controlled Machines). The present embodiment is a workable solution that integrates all systems in the built environment with a body that is chiefly indwelt by the Holy Word, which is Spirit (John 6:63), which is God (John 4:24 New American Standard Bible), which is love (1 John 4:8 New American Standard Bible). And the fruit of Love is nothing but Holy GOODS and SERVICES of the Holy Nation—Agape Kingdom;
7. In the past though computers were seen adorned with neckties in advertisements and cartoons, my embodiments have the machine space itself as the necktie imitation giving it the unappreciated advantage of being perceived as Personal Extender;
8. Moreover this modification of the computational machine with its peripherals and accessories, into a Personal Extender is not suggested by anyone;
9. It solves prior inoperability by personages to rule the world due to the said entropy from n-nefarious people. It is indeed a successful implementation of an ancient idea to rule the world. The common denominator being the church, it is fully equipped to provide a plurality of Personages to member the architecture at various levels of the said distributed “erect” Cyborg;
10. This embodiment is more workable as a problem solving system at large, than the computer, prior art, or the other embodiments because humans are always on top of things either to impose more problems or take control. What makes my system workable is that it solves the need to have command over our environment and subdue it. This is achieved by empowering the Born-Again Personages who will be the “Controller” Use Cases of the environment even at the initial stages of the designing and drafting of the system's specifications;
11. The user and the machine (Prior art) are combined without the added requirement of new and costly manufacturing technologies to make the said embodiments of the invention. This synergistic result was not foreseeable by those well versed with the prior art;
12. Contrary to prior art teaching that the Big Beast of prophesy (Revelation 13 New American Standard Bible) can never be realized in and through a Computer, the said embodiments of the invention demonstrate the manifestation of the Global Cyborgic Conglomerate Superhuman Anti-Christ, who needs to be dealt with through a suitable Cyborgic Christian Personage;
13. For centuries the glorious coming of Christ (i.e. with His angels—the harvesters) has been awaited. Thus the embodiment of the said invention solves the long-felt need for the visible presence and reign of Christ on earth—an answer to the prayer for His kingdom to come on the earth;
14. Overall governability increased because entropy is reduced at every stage of the decussating pyramidal necked service architecture of the system world over.
15. The combination of the user and the system have been suggested in the User-Centred System, however the combination did not take the embodied cognition of a Personal Extender on the one hand and the resulting Augmented Persona for the Cyborg on the other, except when both are encased in the said manner with the Necktie encasement/wrapper figuratively (FIG. 2), where the literal hardware may be anywhere on the said human-body/corporate/conglomerate. It is a Prosthetic/Extender Device and not a Turing Machine because, in real life the neck-tie is situated at the neck, right below the head (something which we know has the pre-eminence). Thus, even though the Prosthetic device may be smart to take care of certain tasks involuntarily that come its way both from above and below without taking it up or below the hierarchy, it is still a “slave” by reason of the Necktie Metaphor Environment; specifically its placement below the head and due to its function. We have a model in Christ Himself, who is Lord of lords, He remains the Prime-Servant—one who has come to serve and not be served. We who follow Him have long before willingly subscribed as His bond-slaves.
16. Simply calling the combination of Computer and the USER, a “User-centred System” will not change anything because the word, “USER” implies a machine that is being used, where the relationship is still not a Master-slave relationship. Moreover the combination of Computer and the user in a User-Centered System would not operate as a User-centred system because of the Computer Metaphor Environment barrier that the Computer system possesses. The Computer metaphor environment impedes the machine to be perceived as a real Extender (Prosthesis) to the mind/self;
17. We also have the synergistic effect of the formation of a Super-Augmented Persona to serve as an eThrone at the “e-neck” for a Government to “sit on”;
18. References in the religious spectrum teach away from combining the spiritual with the material because man has historically yielded to the pleasures that the material world brings. Since Embodiment Mode 1A gives preeminence to the Spirit, I have shown that it is not only practical and ethical but also the right thing to combine the two, given that there has been a sharp rise in civil, social and criminal injustices the world over and anarchy prevailing;
19. As the world is reeling under racism (even today in the form of racial profiling), castism and untouchability, a new form of classification/profiling based on virtue/humility through the said method is necessary to counter those forces;
20. This method is a must for those who want to be perfected in Christ because it is only as a whole we are perfected (John 14:19-20; Hebrews 11:38-40 NAS Bible). That is, those who went ahead of us live in Christ and Christ lives in us today, which means they live in us and are perfected even as we ourselves are being perfected;
21. This method is a must for those who want the whole world to believe that Jesus was sent from God because it is only when they see oneness, which is made possible through a visible and single Head, and a single Holy Spirit in the Body that the whole world will believe (John 17:21-23);
22. The fact is that most of the prior art speak about a User-Interface which teach away from the User-centered System approach because user interfaces per se are needed only for independent automatons or Turing Machines. Through embodied cognition the unique Cyberspace Augmented Persona/Meatspace, in place of a User-Interface (passeé) gives the meaning that digital and real interactions are integrated seamlessly as well as synergistically, at various levels in the Necked Service Oriented Architecture.
23. The Network Blob is hard to manage because digital robber barons are on the loose and perform covert operation, whereas Global Cyborgs even if they are many have manifestation as entities and can be dealt with;
24. The advantages of such an architected Soft Paternalism are that it empowers the engine of the government and streamlines trust.

While the above description contains many specificities, these should not be construed as limitations on the scope of any embodiment, but as exemplifications of the presently preferred embodiments thereof. Many other ramifications and variations are possible within the teachings of the various embodiments. For example the Vision and Projection parts of the Personal Extender apparatus can be literal to some extent as well as figurative, located anywhere, including over-head; the tags can be electronic RFIDs, instead of discrete colors or specific skin colors, etc. Also, the Architecture may be extrapolated from the one included here to a more universal/general one that has different levels of Lordships and applied for different religions. Thus it can be shown that Jesus Christ is Lord of lords and the King of kings.

1. A system and method for augmenting Persona for humans comprising the arranging of a user and a machine (including Super-Computers, Network-is-the-Super-Computer, etc) in a Head (or any part of the body) and a Extender/Environment-Integrator relationship, whereby said relationship produces synergy and said user's Persona is augmented

2. The system as claimed in claim 1, wherein said Personal-Extender/Environment-Integrator is a Necktie Imitation

3. The Necktie Imitation claimed in claim 2 includes pocket data processing device connected to a global network with handwriting, speech, gesture and image synthesizing/processing software, a camera on the forehead, an ear-phone with microphone and/or a projector

4. The method as claimed in claim 1, wherein the Personal-Extender/Environment-Integrator is implemented through black-box modernization technique whereby the general purpose data processor is reconfigured

5. The method as described in claim 2, wherein the Body part consists of space (Laborspace) available in the world including in Cyberspace, in which case Cyberspace may be layered over the Persona/Meatspace to achieve the desired result of augmentation/extension

6. A means, namely a Necked Service Oriented Architecture comprising of an Inverted Pyramidal Bridespace (Governance/Spiritual Support-space) and an Upright Pyramidal Christocratic-space (Governed Support-space)

7. A means, as claimed in claim 6 where the Necked Service Oriented Architecture has Christocratic governance

8. A means as claimed in claim 6 or claim 7, where control in the head and operation in the body is decussated between eastern and western regions of the earth, whereby control is achieved for the head as shown in FIG. 1B

9. A means as claimed in claim 6, where the greatest (most empowered) service of the inverted pyramid is below (i.e. in the (centre serving as a neck), and the greatest (most empowered) service in the upright pyramid is just below the neck (i.e. at the top of the upright pyramid), whereby the neck has supremacy both above through voluntary servitude in the inverted pyramid, and below in the upright pyramid after the fact (i.e. after manifestation of Super Cyborg)

10. A means as claimed in claim 9, where everyone (meaning, their Services represented with the suffix “space”) is assessed with said Service Selection Policy's Implementation Process and other custom set of assessments, ranked and placed in the Necked Service Oriented Architecture

11. A means as claimed in claim 10, where entropy is reduced through the said architecture whereby information from subordinates/superiors/Super-Augmented Persona is taken as sense perception (insight) i.e teleworking and telegovernance and thus reducing the said n-entropy, and the presentation of 7 plus or minus 2 units of information in the form of soft or hard units to the Ordinate Human Component at any given time or at any given node except when he is sleeping or taking rest, whereby it enables fewer resources to be present as we come closer to neck level from either below or above

12. An eThrone and method for manifestation of Pan-Environment Super Cyborgs, Global Cyborgic Conglomerate Super-humans or Christs comprising:
a. The rightful people space, namely Bridespace, arrived at using the Service-Selection-Policy's Implementation Process as shown in FIG. 3
b. Development of Necktie imitating Personal-Extender/Environment-Integrator shown in FIG. 2
c. A virtual wrapping of the membership/Citizenship of the said Global Cyborgic Conglomerate Christ/Superhuman with a global network of such apparatuses interconnected and fully integrated with all kinds of Goods and Services either supplied or procured through it by the membership/citizenship, which takes on an embodied cognition of having wrapped/clothed him with clean-linen cloth when it comes to Christ and no clothing when it comes to a Super-human
d. And virtually tying-in the said wrapped-up body, which now consists of a plurality of metaphor objects of humans, systems, machines, organizations and other built environment using a computer and associated integration means
e. Structuring the Christocratic Necked Service Oriented Architecture and a Lord's Necktie Personal-Extender/Environment-Integrator by way of ranking and placing each member in the architecture as claimed in claim 10
f. To result in a cognition through the said perception model of having tied a virtual Neck-tie around his (Cyborg's) neck and thus rendering or recasting the computer-Network as a Necktie-imitating Personal/Christ's Extender/Environment-Integrator that has the capability of bringing insight from below and above in the architecture as well as from everywhere else as claimed in claim 11 and perform tasks
g. And also to result in a Super-Augmented Persona at the cross-section of the aforementioned “tied neck” in claim 12d by incorporating and employing all the members of Bridespace and Christocratic-space in the said Architecture, whereby governing of the new world order is made possible

13. The method claimed in claim 1, wherein it provides a morphological solution to the macroscopic problem of n-entropy i.e. loss of control/information in the global anarchy by super-augmenting a persona through the eThrone with the architecture as claimed in claim 12 to manifest a pan-environment super-cyborg for global governance.
